(19) United States
(12) Patent Application Publication
(10) Pub. No.: US 2005/0057031 A1
(43) Pub. Date: Mar. 17, 2005

(54) Joystick-operated driving system

(76) Inventor: Bruce Ahnafield, Indianapolis, IN (US)

Correspondence Address: MAGINOT, MOORE & BECK;BANK ONE CENTER/TOWER, 1111 MONUMENT CIRCLE, INDIANAPOLIS, IN, 46204, US

(21) Appl. No.: 10/903,444

(22) Filed: Jul. 30, 2004

Related U.S. Application Data
(60) Provisional application No. 60/491,740, filed on Aug. 1, 2003.

(51) Int. Cl. B62D 1/00

(52) U.S. Cl. 280/771

(57) ABSTRACT

A system for use by a physically impaired driver for controlling a vehicle includes an actuator assembly operably coupled to the pedals and an actuator assembly coupled to the steering shaft. The actuator assemblies include electrical motors operable to depress the brake pedal and the accelerator pedal and to rotate the steering shaft. A joystick controller is mounted to the vehicle and is operable in a fore-aft direction to control braking and acceleration, and can be tilted side-to-side to control vehicle steering. The steering control feature utilizes three sensors to determine a commanded steering and three drive motors to convert that command into a desired steering.

### CROSS-REFERENCE TO RELATED APPLICATION

This application claims priority to co-pending provisional application No. 60/491,740, which was filed on Aug. 1, 2003, by the present inventor.

### BACKGROUND OF THE INVENTION

The present invention relates to a system for controlling a motor vehicle, and particularly for operating the vehicle accelerator and brakes. This invention can be readily applied to vehicle control systems for physically impaired drivers.

A conventional motor vehicle, such as an automobile, is designed for a driver having full and substantially unrestricted use of all of their limbs. The standard vehicle controls include a rotary operating steering wheel, a depressible brake pedal, and a depressible accelerator pedal. Of course, it is known that the steering wheel is operated manually, while the brake and accelerator pedals are operated by the driver's feet. Current production vehicles assume that the driver has full use of his/her hands and feet in order to operate these vehicle controls.

Unfortunately, a significant percentage of the driving population does not have full use of all of their limbs. For instance, drivers with certain physical disabilities may be unable to use their legs to operate the brake and accelerator pedals. Although no production vehicles have been developed to account for physically-impaired drivers, a significant amount of effort has been expended in developing systems that can be integrated into an existing vehicle control system to accommodate this driving population. One such system is depicted and described in U.S. Pat. No. 4,722,416, which issued on Feb. 2, 1998 to one of the inventors of the present invention. A system embodying the teachings of the '416 patent has been sold by Ahnafield Corporation as its “Joystick Driving Control®” system. The basic components of this system are shown in FIG. 1. In particular, a vehicle V, which includes stock controls, such as steering wheel S, brake pedal B, and accelerator pedal A, is provided with a braking/acceleration control system 10 that integrates with the vehicle controls. A joystick controller 12 is provided that can be manually manipulated by the physically-impaired driver. This joystick controller is linked to a control box 14 which carries an electronic circuit or processor that produces control signals in response to movement of the joystick controller 12. These signals operate a brake control cylinder 16 or an accelerator control cylinder 18. These cylinders are part of a hydraulic system that can be actuated by signals from the control box 14 to depress or retract either of the two control pedals B, A. In certain applications, the joystick controller 12 can be a two-axis joystick, meaning that movement in one direction, say left or right, can be used to operate the steering in lieu of the steering wheel S, while movement in a perpendicular direction, such as forward and backwards, controls either the brake or accelerator pedal.

While the Joystick Driving Control® vehicle control system has been very successful in improving the freedom and mobility of the physically-impaired driver, there is always room for improvement. One problem faced by this and other vehicle control systems is that they require significant modification of the existing vehicle and are very difficult and time-consuming to install. Another difficulty faced by some driving control systems is the “fail-safe” mode of operation of the system. For instance, in some prior vehicle control systems, a failure of certain components of the system can compromise the ability of the driver to achieve a safe, controlled stop of the vehicle.

The Joystick Driving Control® system of the Ahnafield Corporation has implemented a fail-safe condition in which all actuators return to a neutral position so that there can be no inadvertent application of the accelerator. In addition, this system provides redundancy for the brake actuators so that the failure of one actuator does not leave the brake pedals inoperable. While the Joystick Driving Control® system has an impeccable safety record, there again is always room for improvement to insure the continued safety of the physically-impaired driver. Thus, there remains a need for improvements to vehicle control systems, particularly those intended for use by the physically-impaired driver.

### SUMMARY OF THE INVENTION

To address this continuing need, the present invention provides a system for use by a physically impaired driver for controlling the steering, braking and acceleration functions of a vehicle. In one embodiment, the system includes a manually manipulated hand controller, movable in a first direction to control the brake pedal and in an opposite second direction to control the accelerator pedal. The hand controller is manipulated in a direction perpendicular to the first and second directions to control the vehicle steering.

The present invention provides a steering system for a motor vehicle for use by physically impaired driver that integrates with steering shaft and stock steering wheel of the vehicle. In one embodiment, the system comprises an input device independent of the stock steering wheel operable by the driver to generate a control signal indicative of a desired steering input for the vehicle, a controller receiving the control signal and operable to generate a steering command in relation thereto, and a steering apparatus coupled to the steering shaft. The steering apparatus includes a steering gear coupled to the vehicle steering shaft so that rotation of the steering gear rotates the steering shaft, at least three drive gears, an idler gear in meshed engagement with the steering gear and the drive gears to transmit rotation from the drive gears to the steering gear, and at least three motors each driving a corresponding one of the drive gears in response to the steering command received from the controller.

In a further feature of the invention, the steering apparatus includes a mechanism coupled to the idler gear operable to disengage the idler gear from the drive gears. This mechanism is operable to shift the idler gear to a retracted position in relation to the steering gear in which the idler and steering gears are no longer in engagement. Preferably, the drive gears are configured so that the idler gear remains meshed with the drive gears when the idler gear is in the retracted position.

In another embodiment of the invention, a steering system for a motor vehicle comprises an input device independent of the stock steering wheel operable by the driver to generate a control signal indicative of a desired steering input for the vehicle, a controller receiving the control signal and operable to generate a steering command in relation thereto, and a steering apparatus that includes a steering gear coupled to the vehicle steering shaft so that rotation of the steering gear rotates the steering shaft, a drive gear, a motor rotating the drive gear in response to the steering command received from the controller, an idler gear in meshed engagement with the steering gear and the drive gears to transmit rotation from the drive gears to the steering gear, and a mechanism coupled to the idler gear operable to disengage the idler gear from the drive gear.

In still another embodiment of the invention, a control system is provided for a motor vehicle having stock controls including a steering shaft connected to a stock steering wheel, a stock brake pedal and a stock accelerator pedal. The system comprises an input device independent of the vehicle stock controls operable by the driver to generate control signals indicative of a desired steering input and a desired braking/acceleration input for the vehicle. The input device includes a two-axis joystick mounted on a gimbal so that the joystick can be pivoted in two mutually perpendicular directions, a first gear coupled to the gimbal and rotatable in a first of the perpendicular directions, a first position sensor driven by the first gear and operable to produce a steering signal in relation to the rotation of the first gear, a second gear coupled to the gimbal and rotatable in a second of the perpendicular directions, and a second position sensor driven by the second gear and operable to produce a braking/acceleration signal in relation to the rotation of the second gear.

The system includes a controller receiving the steering signal and operable to generate a steering command in relation thereto, and receiving the braking/acceleration signal and operable to generate a braking/acceleration command in relation thereto. The system is further provided with a steering apparatus including a steering gear coupled to the vehicle steering shaft so that rotation of the steering gear rotates the steering shaft and a motor-driven drive gear train in meshed engagement with the steering gear and operable to rotate the steering gear in response to the steering command received from the controller, as well as a braking/steering apparatus that includes a motor-driven brake actuator coupled to the stock brake pedal and operable to depress the brake pedal in response to the braking/acceleration signal and a motor-driven accelerator actuator coupled to the stock accelerator pedal and operable to depress the accelerator pedal in response to the braking/acceleration command received from the controller.

In a further feature of this embodiment, the input device includes a first limit switch associated with the second gear and operable at a pre-determined limit position of the second gear to produce a first limit signal. The controller is operable upon receipt of the first limit signal to deactivate the motor-driven accelerator actuator to prevent depression of the stock accelerator pedal. In yet another feature, the control system further comprises an emergency braking system and the input device includes a second limit switch associated with the second gear and operable at a pre-determined limit position of the second gear to produce a second limit signal. The controller is operable upon receipt of the second limit signal to activate the emergency braking system.

In an additional embodiment of the invention, a steering system for a motor vehicle having a steering shaft connected to a stock steering wheel, the system comprises an input device independent of the stock steering wheel operable by the driver to generate a control signal indicative of a desired steering input for the vehicle, an accelerometer mounted within the vehicle and operable to generate an lateral acceleration signal in relation to the lateral acceleration of the vehicle and a controller receiving the control signal and the lateral acceleration signal, the controller operable to generate a steering command in relation to the control signal that is reduced in relation to the magnitude of the lateral acceleration signal only when the lateral acceleration signal is greater than a pre-determined magnitude. A steering apparatus includes a steering gear coupled to the vehicle steering shaft so that rotation of the steering gear rotates the steering shaft and a motor-driven drive train in meshed engagement with the steering gear and operable to rotate the steering gear in response to a steering command issued by the controller.

It is one object of the invention to provide a system that can be easily managed by a person having a physical disability that might otherwise prevent that person from operating a motor vehicle. One important object is to provide such a system that can provide that driver with the greatest ability to control the vehicle steering, braking and acceleration.

A further object of the invention resides in features that make the system easy to retrofit to an existing vehicle, specifically with as little disruption to the driver-side area of the vehicle. Yet another object is accomplished by features that ensure stable and reliable actuation of the brake pedal, especially in an emergency braking condition.

These and other objects, as well as many benefits of the present invention, will become apparent upon consideration of the following written description, taken together with the accompanying figures.

### DESCRIPTION OF THE FIGURES

FIG. 1 is a perspective view of one type of prior art vehicle control system.

FIG. 2 is perspective view of a joystick controller component in accordance with one embodiment of the present invention.

FIG. 3 is a top perspective view of the internal mechanisms of the joystick controller component shown in FIG. 2.

FIG. 4 is a top elevational view of the internal mechanisms of the joystick controller shown in FIG. 3.

FIG. 5 is a bottom elevational view of the internal mechanisms of the joystick controller shown in FIG. 3.

FIG. 6 is a side elevational view of the internal mechanisms of the joystick controller shown in FIG. 3.

FIG. 7 is a side elevational view of the internal mechanisms of the joystick controller shown in FIG. 3, from a side perpendicular to the side view shown in FIG. 6.

FIG. 8 is a side elevational view of the internal mechanisms of the joystick controller shown in FIG. 3, from a side opposite the side view shown in FIG. 7.

FIG. 9 is an exploded view of the steering, braking and acceleration components of the joystick control system of the present invention.

FIG. 10 is a top elevational view of an acceleration/braking assembly included in the joystick control system depicted in FIG. 9.

FIG. 11 is a perspective view of the steering assembly includes in the joystick control system depicted in FIG. 9.

FIG. 12 is a perspective view of the steering assembly rotated 90° relative to the view depicted in FIG. 11.

FIG. 13 is a perspective view of the steering assembly rotated 90° relative to the view depicted in FIG. 12.

FIG. 14 is a side partial cross-sectional view of the idler gear of the steering assembly shown in FIGS. 11-13.

FIG. 15 is a schematic representation of the meshed engagement between the gears of the steering assembly shown in FIGS. 11-13.

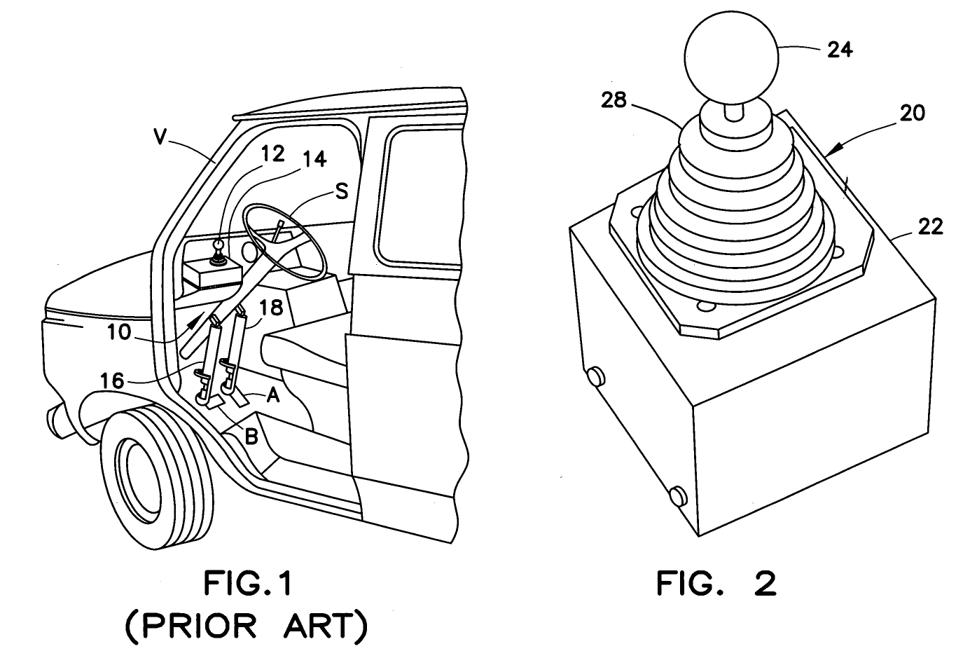

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

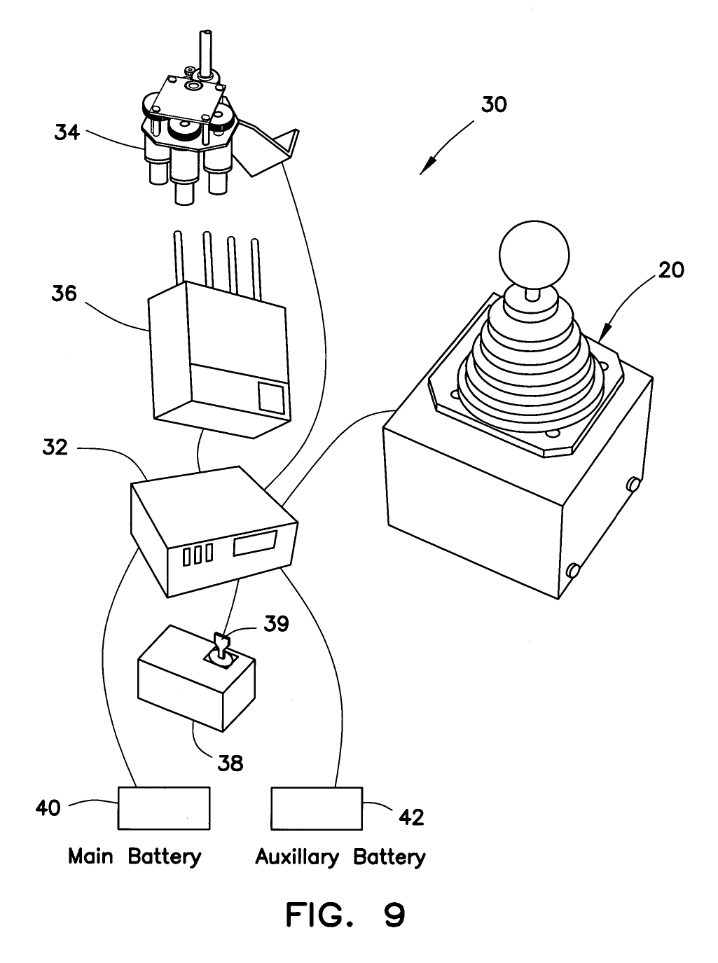

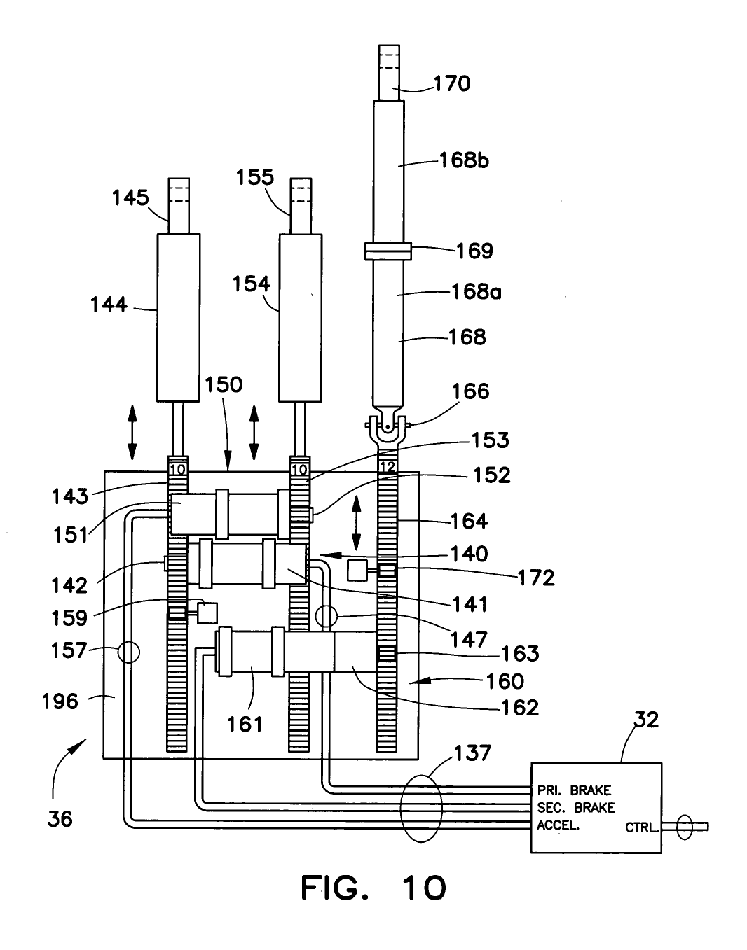

The present invention contemplates a novel joystick controller 20 as shown in FIG. 2, and joystick control system 30, such as the system depicted in FIG. 9. The control system 30 includes the joystick controller 20 which is manually manipulated by the vehicle operator to provide control signals to a processor or electronic control unit 32. This control unit 32, which is preferably a microprocessor-based device, processes signals received from the joystick controller and transmits appropriate control signals to a steering assembly 34 and/or an acceleration/braking assembly 36. An annunciator panel 38 can be included to provide visual indications regarding the status of the control system 30 and to energize the control system. The panel can include a key lock 39 that must be turned on to activate the joystick controller and the other components of the control system 30. It is contemplated that the stock driver controls (e.g., steering wheel S and the pedals B and A) will be free for unfettered operation unless the key 39 on the annunciator panel is turned on.

Electrical power to the system is preferably supplied through the control unit 32 from the primary vehicle battery 40. Optionally, and preferably, an auxiliary power source 42, which is preferably a back-up battery, is provided which can be mounted within the vehicle in parallel with the vehicle's primary battery 40. As will be described herein, the acceleration/braking assembly 36 includes an emergency braking feature. In accordance with the preferred embodiment, this emergency braking feature is directly connected to the auxiliary power source so that braking remains available even on a failure of the vehicle's electrical system. It is contemplated that this auxiliary power source 42 is continuously available; however, remaining energized at all times will unnecessarily drain the power source. Thus, the auxiliary batter 42 is linked to the vehicle gear shift selector so that when the vehicle is placed in “PARK” the auxiliary source is disconnected from the control system 30 in order to conserve the battery. Of course, when the vehicle ignition is turned off, both the primary and auxiliary power sources are disconnected from the system

Returning to FIG. 2, the joystick controller 20 includes a control box 22 which houses the internal mechanisms described herein. A manual knob 24 is supported on the control box for movement in multiple degrees of freedom or along multiple axes. Preferably, the knob is supported for two axis movement, with movement in the fore-aft direction controlling acceleration and braking, and movement in the transverse, or side-to-side, direction controlling the vehicle steering. The joystick controller 24 is shown with a spherical knob 24; however, it is understood that other manipulable interfaces can be provided and tailored to the physical capabilities of the vehicle operator.

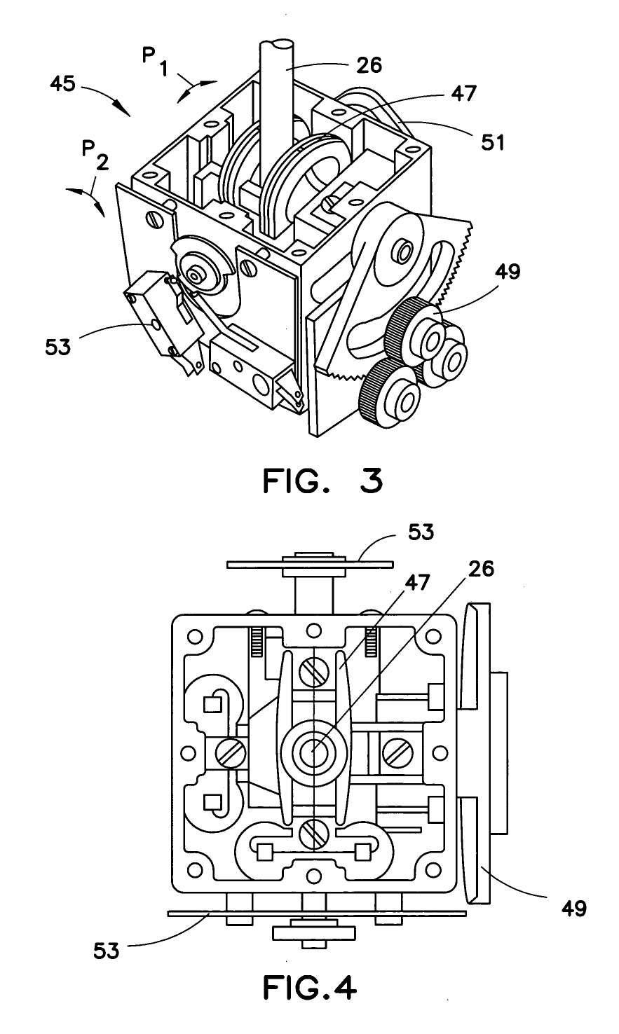

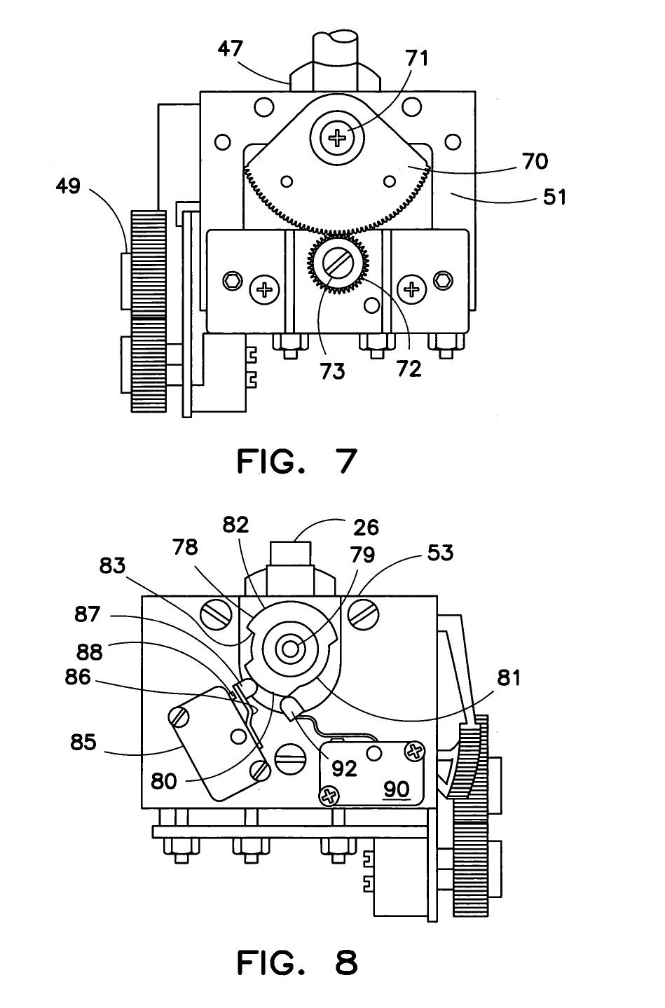

Referring to FIGS. 3-8, the internal mechanism of the joystick controller 20 is depicted. The controller includes a support shaft 26 onto which the knob 24 is mounted. The support shaft is concealed by a rubber bonnet 28 (FIG. 2) as is conventional in the art. The support shaft 26 is supported on a gimbal 47 (FIGS. 3-4) that provides the two-axis motion capabilities for the joystick. The gimbal is configured to permit pivoting in a first direction P₁ and a perpendicular second direction P₂, as represented by the curved arrows in FIG. 3. In the illustrated embodiment, pivoting of the joystick in the direction P₁ provides a steering input signal to the processor 32, while pivoting in the direction P₂ provides an acceleration or braking signal. The joystick apparatus 45 includes a steering signal mechanism 49 that is actuated when the joystick is pivoted in the first direction P₁, and an acceleration/braking signal mechanism 51 that is actuated when the joystick is pivoted in the second perpendicular direction P₂. The joystick apparatus 45 also includes a limit switch mechanism 53 that is operated when the joystick pivots in the second direction P₂ to provide emergency braking and acceleration de-clutching functions as described herein. The limit switch mechanism 53 and the acceleration/braking signal mechanism 51 can pivot in unison, both mechanisms being mounted on a common axis of the gimbal structure 47.

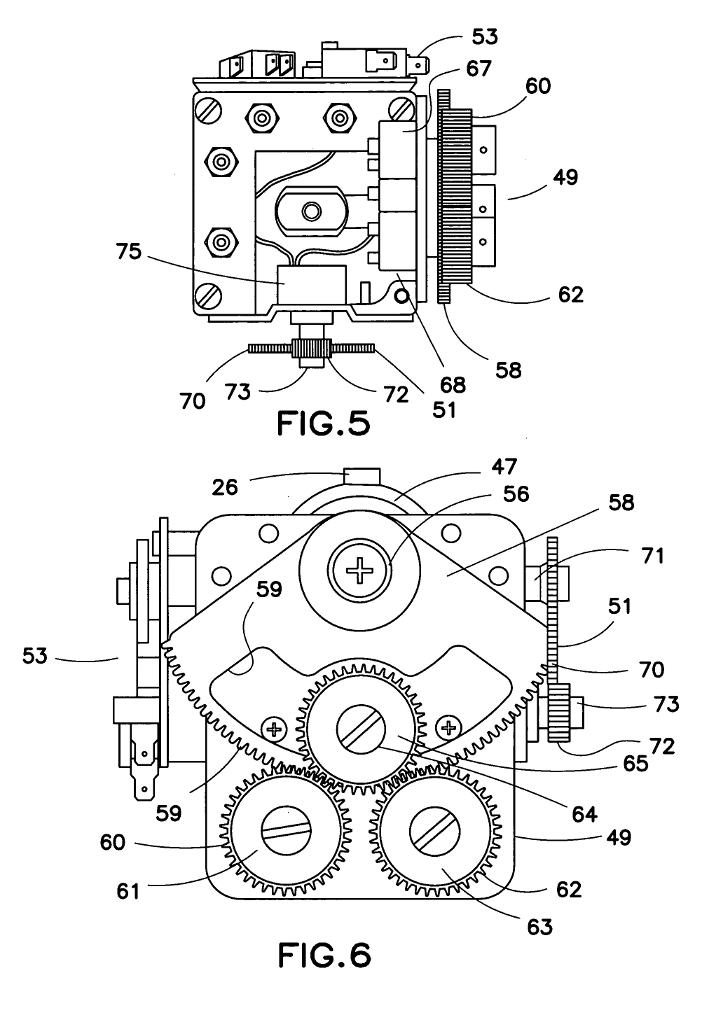

Details of the steering signal mechanism can be discerned from FIGS. 5 and 6. A first axle 56 connects a crescent gear 58 to the gimbal structure 47 so that the crescent gear pivots in the first direction P₁. The crescent gear includes rack gear teeth 59 that mesh with teeth on gears 60 and 62. These gears 60, 62 include corresponding spindles 61, 63 that are connected to respective position sensors 67, 68 (see FIG. 5). In the preferred embodiment, the sensors are rotary potentiometers, although other types of position sensors are contemplated that can convert rotation of the gears 60, 62 to position signals.

In the illustrated embodiment, as the gears 60, 62 are caused to rotate by rotation of the crescent gear 58, the spindles 61, 63 rotate within the position sensors 67, 68. The position sensors then generate a signal indicative of a degree of rotation of the joystick in the direction P₁, which in turn is indicative of a steering command issued by the vehicle operator. The steering signal mechanism 49 includes a third gear 64 that meshes with the other two gears 60, 62 so that all three gears rotate in unison. The third gear includes its own spindle 65 that actuates a corresponding position sensor (not shown). Thus, in accordance with one feature of the present invention, the steering signal mechanism 49 provides three position signals, all indicative of a steering command by the vehicle operator. It can be noted that the crescent gear 58 defines an opening 59 through which the spindle 65 for the third gear 64 extends.

These three signals are fed to the processor 32 where a voting procedure is implemented. In other words, the processor receives all three signals and compares them to each other. If the signal value of all three is the same, the processor issues an appropriate steering command to the steering assembly 34. Further, if two of the three signals are substantially the same (i.e., within a predetermined difference), the average of those two signals are used to produce a steering command. The use of three gears 60, 62 and 64, and three position sensors (including the sensors 67 and 68) ensure that an erroneous steering signal is not generated in relation to the operator input. It is contemplated that this voting procedure can be accomplished electrically or digitally with accompanying software.

If none of the three signals are substantially the same, an error condition is detected and the processor triggers the annunciator 38 to issue an alarm, including an audible alarm. However, since the vehicle is still operating, the processor must provide some steering command to the steering apparatus 34. Various default protocols can be envisioned, including retaining the previously issued steering command or averaging the current signals.

In the preferred embodiment, the processor 32 receives the signals from the position sensors 67, 68. The degree of angular rotation of the sensors is directly related to the amount that the joystick is pivoted by the operator. As can be contemplated, the neutral position of the joystick illustrated in FIG. 6 corresponds to a zero degree steering input—i.e., straight line driving. The joystick can be rotated through about ±45° which is calibrated through the processor to call for the normal range through which the wheels of the vehicle can turn. In accordance with one feature of the preferred embodiment of the invention, the processor translates the input signals from the joystick position sensors into a steering signal provided to the steering assembly 34 as a function of the lateral acceleration of the vehicle. Lateral acceleration data is obtained from accelerometers (not shown) mounted within the vehicle that provide an acceleration signal to the processor.

At high speeds, where the lateral acceleration is highest during a turn, the processor reduces the requested steering magnitude so that the steering signal ultimately provided to the steering assembly calls for a smaller degree turn than requested. The purpose behind this ratioing of the requested steering angle is to avoid an unsafe turn at high speeds. As the lateral acceleration decreases, the processor reduces the reduction ratio applied to the requested steering angle. At low speeds, where the lateral acceleration is minimal, the actual applied steering angle is nearly equal to the requested steering angle.

The present invention preferably utilizes a directional control system like that disclosed in U.S. Pat. No. 6,301,534, which issued on Oct. 9, 2001, the disclosure of which is incorporated herein by reference. This patent describes the use of accelerometers mounted in the vehicle to measure the lateral acceleration during a turn. This system utilizes an algorithm that relates the final turning angle to the accelerometer data as well as the user requested acceleration and turn angle. The processor 32 of the present joystick control system 30 implements the algorithms and equations set forth in the '534 Patent to obtain an actual steering signal.

One difficulty with the direction control system disclosed in the '534 Patent is that it can be inaccurate when the lateral acceleration is zero or essentially zero. A null lateral acceleration can arise during a turn when the turn is at very low speeds, such as during a parallel parking maneuver, or when the vehicle is skidding, such as on ice or wet pavement. In order to overcome this difficulty, the present invention contemplates a routine within the processor that allows the operator input turn angle to override the calculated or ratioed turn angle under zero or near zero lateral accelerations. Thus, when a vehicle operator is attempting to parallel park, the processor will apply the user requested turn angle directly to the steering assembly 34. More specifically, the processor filters the incoming acceleration signal so that a signal must have a magnitude above a pre-determined threshold before the above described reduction ratio is applied.

Referring to FIGS. 5-7, details of the acceleration/braking signal mechanism 51 of the joystick controller 20 will be described. The mechanism includes a gear 70 mounted on an axle 71 that is connected to the gimbal structure 47. This axle rotates with the gimbal in the direction P₂ (FIG. 3) to effect an acceleration or a braking command. A forward pivoting or the joystick controller 20 by the vehicle operator can correspond to acceleration, while an aft or rearward pivoting commands braking. Of course, the fore-aft relationship to acceleration and braking can be reversed to suit the particular needs of the vehicle operator.

The gear 70 meshes with a driven gear 72, which is mounted on a spindle 73 of a position sensor or potentiometer 75. As with the steering signal mechanism, the position sensor 67 provides an acceleration or braking signal to the processor 32 in relation to the rotational movement of the gear 70, and ultimately the pivoting movement of the joystick. The processor then translates the signal received from the position sensor 75 into an appropriate command to the acceleration/braking assembly 36. It should be appreciated that the gimbal structure 47 permits simultaneous movement or pivoting along both directions P₁ and P₂. Thus, an acceleration or braking command can be issued even while the vehicle is being turned in response to a steering command.

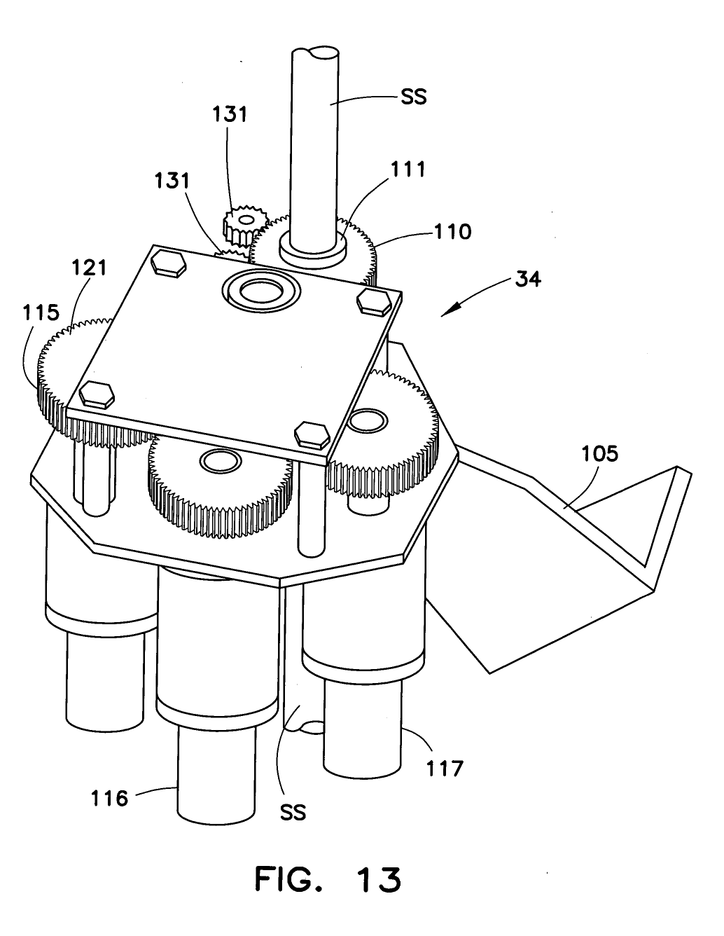

In the preferred embodiment, the position sensor 75 output is directly correlated to an acceleration or a braking signal provided to the assembly 36. This assembly can be configured as shown in FIG. 10, and as described in co-pending utility patent application Ser. No. 10/632,543, filed on Aug. 1, 2003, in the name of the present inventor and entitled Joystick-Operated Driving System, the disclosure of which is incorporated herein by reference. Most particularly, the discussion of the control assembly at pages 20-26 and FIGS. 12-14 of this co-pending application are specifically incorporated herein. By way of background the general features of the assembly 36, as disclosed in the above-cited co-pending application, can be discerned from FIG. 10 of the present application.

The assembly 36 is configured to depress the stock brake pedal B and stock accelerator pedal A by way of electric motors. Thus, the motor control circuitry implemented within the processor 32 transmits various control signals through motor control wires 137 fed to the actuator system or assembly 36. In the preferred embodiment, the brake pedal B is controlled by a primary brake assembly 140 and a secondary brake assembly 150. The two assemblies provide a fail-safe redundancy in the event of failure of one of the two brake assemblies. Each assembly 140, 150 includes a corresponding brake or motor 141, 151, drive spindle 142, 152 and rack gear 143, 153. Each rack gear is connected to a drive link 144, 154, each of which terminates in a drive tab 145, 155. A linking bracket is provided to mate the drive tabs to the brake pedal arm. The assembly 36 can be pivotably mounted to the vehicle, such as under the dashboard, to insure that the driving force generated by the primary and secondary brake assemblies is always perpendicular to the brake pedal arm, even as the arm is itself pivoted as the brake pedal B is depressed.

As explained above, power to the electrical components of the brake assemblies 140, 150 is at least initially supplied by the vehicle primary battery 40 (FIG. 9). However, as also explained above, the emergency braking feature of this system 30 requires that power be constantly available to the at least one of the brake assemblies. Thus, in the preferred embodiment, the second brake assembly 150 also receives power from the auxiliary battery 42, or optionally only receives power from the auxiliary source.

The acceleration/braking assembly 36 also includes an accelerator actuator assembly 160. The actuator assembly includes a drive motor 161 that rotates a drive spindle 163, preferably through a transmission, such as planetary gearing, to step down the motor speed to an appropriate speed for the rest of the accelerator actuator system 138. In accordance with the preferred embodiment, the actuator assembly includes a clutch 162 between the motor/transmission and the spindle. In a most preferred embodiment, the clutch is an electromagnetic clutch that is activated by a signal from the control circuitry of the processor 32 through one of the control wires 137. The clutch 162 can be a free-wheeling clutch when no electrical current is provided to the clutch. When power is applied to the drive motor 161 and clutch 162, the clutch engages so that rotation of the motor leads to direct rotation of the drive spindle 163. This clutch provides a fail-safe feature that prevents unwanted vehicle acceleration by positively disconnecting the actuator assembly 160 from the stock vehicle accelerator pedal under certain conditions described herein. Advantageously, the clutch can also re-engage when these certain conditions have passed to resume normal accelerator control.

As with the primary and secondary brake assemblies, the accelerator assembly includes a rack gear 164 that is in meshed engagement with the drive spindle 163. The rack gear 164 terminates in a U-joint 166 that mounts to the drive link 168. Thus, the U-joint 166 permits multiple degrees of freedom of movement to account for actuation of the accelerator assembly. Preferably, the link 168 includes a link adjustment feature 169 that permits fine adjustment of the length of the accelerator drive link 168 upon installation, namely by adjusting the relative position of the link halves 168a, 168b. The drive end of the link 168 forms a clevis 170 that can engage the accelerator pedal A linkage by way of a link bracket at 178 and bolt 179, as shown in FIG. 10. The clevis end 170 of the link accommodates pivoting of the link relative to the link bracket 178 as the drive link 168 is extended to depress the accelerator pedal A.

The free-wheeling clutch 162 essentially disconnects the drive link 168 from the motor 161 when power is shut off to the motor and clutch. In the preferred embodiment, the clutch is engaged or disengaged based on a signal from the limit switch mechanism 53 of the joystick apparatus 45. As best depicted in FIG. 8, the limit switch mechanism 53 includes a cam wheel 78 mounted to an axle 79 that is connected to the gimbal structure 47. Preferably, the axle 79 can be part of or attached to the axle 71 for the acceleration/braking gear 70. The axle 79 thus rotates concurrently with the axle 71 as the vehicle operator issues an acceleration or a braking command through the joystick.

The cam wheel 78 includes predefined cam edges that provide means for controlling the clutch 162 for the accelerator motor 161 and means for providing an emergency braking function. In particular, the cam wheel defines a neutral edge 80, an acceleration edge 81, a stop edge 82, and an emergency notch 83. The limit switch mechanism 53 includes two limit switches 85 and 90 that are open or closed as a function of the cam wheel edges. The limit switch 85 includes a spring arm 86 that carries a follower component 87 that bears against the cam wheel as the wheel rotates. The switch includes a pushbutton 88 that is depressed by movement of the spring arm toward the body of the switch. When the spring arm moves away from the switch body, the pushbutton extends to open the limit switch 85. The limit switch 90 is similarly constructed and includes a follower component 92 that bears against the rotating cam wheel 78.

As shown in FIG. 8, the joystick is in its neutral position, meaning that no braking or acceleration commanded. In this position, both follower components 87 and 92 bear against the neutral cam edge 80. The limit switch 85 directs operation of an emergency braking system for the vehicle. This system can be in the form of a four wheel electric braking system that applies braking force to all wheels in an emergency situation. When the joystick is neutral, no emergency condition exists, so the follower component 87 causes the pushbutton 88 to close the limit switch 85. During a normal braking command, the operator rotates the joystick to the left (as oriented in FIG. 8) so that the cam wheel 78 rotates in the counter-clockwise direction. As can be seen in FIG. 8, the neutral edge 80 is sufficiently long so that a normal braking command or pivoting of the joystick does not dislodge the follower component 87 from the neutral cam edge. However, in an emergency condition, the operator will pull the joystick to its farthest position, which causes the cam wheel 78 to rotate until the notch 83 is positioned in line with the cam follower component 87. The follower component is urged into the notch 83 by the spring arm 86, which releases the pressure on the pushbutton 88, allowing it to extend. This action opens the limit switch 85 which issues an emergency braking command to the emergency braking system.

It should be understood that during any braking process, whether normal or emergency, a vehicle acceleration command must not conflict with the braking command. In order to prevent operation of the accelerator pedal A, the present invention contemplates disengaging the clutch 162 so that any rotation of the accelerator motor 161 is not passed through to the rack gear 164 and ultimately to the accelerator pedal. When the cam follower 92 is in the position shown in FIG. 8, the limit switch 90 is closed, which deactivates the clutch 162. Thus, w for any clockwise rotation of the cam wheel 78 from the neutral position shown in FIG. 8, the follower component 92 is always in contact with the neutral cam edge 80. However, if the joystick is pivoted forward, causing the cam wheel to rotate in the clockwise direction, the follower component 92 falls from the neutral edge 80 onto the acceleration edge 81. In this position, the spring arm of the limit switch 90 projects away from the switch body, thereby releasing the pushbutton and opening the limit switch. When the limit switch is open, a command is issued to engage the clutch 162 so that an acceleration command can be translated to movement of the accelerator pedal A.

In addition to the limit switch feature, the processor 32 can be configured to prevent a conflict between a braking command and an acceleration command. In particular, the processor can implement software that overrides any acceleration command upon receipt of a braking command. Thus, even as the accelerator clutch 162 is disengaged, the processor 32 can also provide a null signal to the motor 161.

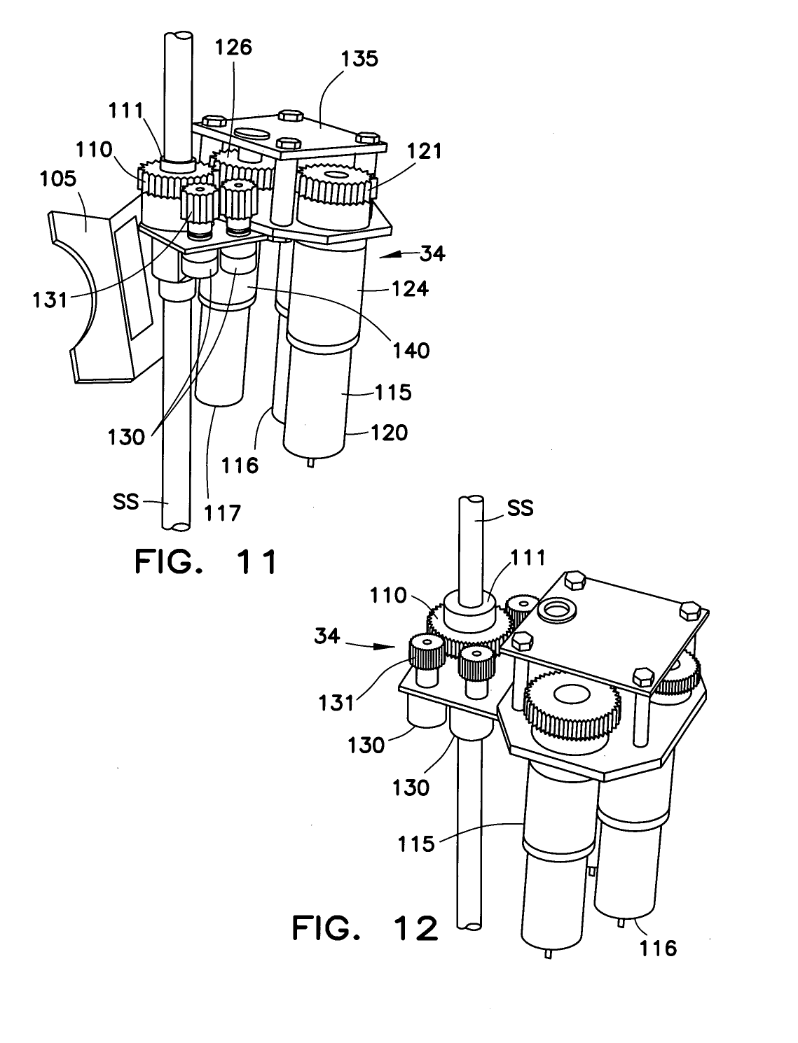

As explained above, the joystick controller 20 also provides means for issuing a steering command to the steering assembly 34, details of which are depicted in FIGS. 11-13. The assembly is shown mounted on the vehicle steering shaft SS. The assembly 34 does not require modification of the existing vehicle steering shaft, although installation of the assembly requires removal of the steering shaft and engagement of the assembly onto the shaft SS before re-installing the steering shaft. The steering assembly 34 is provided with a mounting bracket 105 that allows mounting of the assembly to existing mounting points of the vehicle. For instance, the bracket can fasten to the dashboard underbody or to the steering column structure surrounding the steering shaft.

The steering assembly 34 includes a driven gear 110 that is mounted to the steering shaft SS. In a preferred embodiment, the driven gear is mounted by way of a collet or clamp assembly 111 that is clamped to the steering shaft in a conventional manner. The driven gear itself can include a set screw configuration for fastening the steering driven gear 110 to the steering shaft SS.

The driven gear 110 is rotated by three drive assemblies 115, 116, 117. Each drive assembly includes a motor, such as motor 120, that rotates a drive gear 121. Preferably, each motor includes a transmission 124 that is capable of free-wheel operation under circumstances described below. The transmission can include a clutch arrangement, such as the clutch 162 discussed above. Each of the drive gears, such as gear 121, associated with each drive assembly 115, 116, 117, meshes with an idler gear 126. The idler gear also meshes with the driven gear 110 for rotation of the steering shaft SS.

Optimally all three drive gears rotate together to provide a uniform input to the idler gear 126 and consequently an uniform rotation of the driven gear 110. However, as described above, the processor 32 that issues the steering command to each of the drive assemblies 115, 116, 117 uses a voting approach to determine whether a control signal is applied to each of the drive motors. Thus, if the acceleration signal from one of the position sensors 67 is ignored, the corresponding drive motor is not activated. In this circumstance, the free-wheel characteristic of the transmission 124 is employed.

In another feature of the invention, a number of potentiometers 130 are provided, with each potentiometer being driven by a gear 131 that meshes with the driven gear 110 used to rotate the steering shaft SS. These potentiometers provide angle of rotation information to the processor as the steering shaft is being rotated by the drive assemblies 115. This information can be used as input to the steering algorithm described above that integrates steering information with lateral acceleration data. In addition, the angle data generated by the potentiometers 130 can be used when the lateral acceleration process has been over-ridden. In this circumstance, the potentiometers provide interactive information regarding the position of the steering wheel that can be fed back to the processor.

The present invention also contemplates that the steering assembly 34 will permit use of the stock vehicle steering wheel S without the need for the motor driven capability offered by the assembly. More specifically, the present invention can be disengaged from the steering shaft SS so that the rotation of the shaft is unimpeded or unimpaired by the motors and gearing of the steering assembly 34. In order the accomplish this objective, the invention provides means 140 for translating the idler gear 126 out of engagement with the driven gear 110 that is coupled to the steering shaft SS.

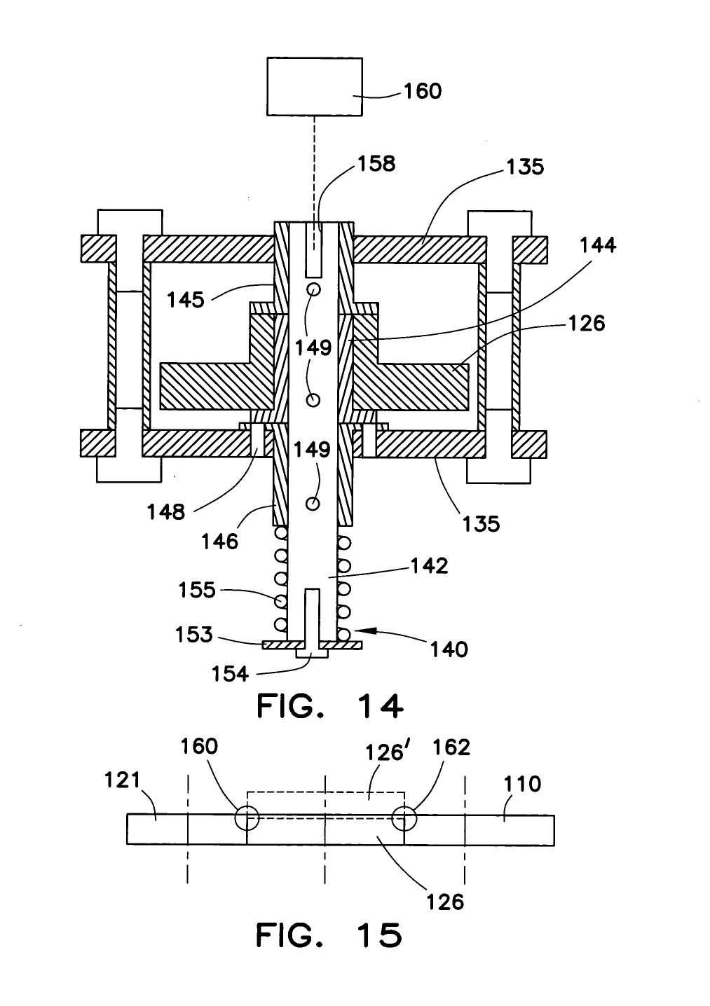

In the embodiment depicted in FIG. 14, the idler gear 126 rotates about an idler shaft 142. The idler shaft is supported on the steering assembly frame 135 by an upper bushing 145 and a lower bushing 146. A bearing bushing 144 is sandwiched between the upper and lower bushings and provides a surface for free rotation of the idler gear 126 as it is driven by the motor-driven gears 121. In one feature of the invention, the idler shaft 142 is supported within the frame 135 so that it can translate upward, thereby moving the idler gear within the frame. The lower bushing 146 includes a number of pins 148 that guide the vertical movement of the bushings and the idler shaft. The bushings 144, 145 and 146 are fastened to the idler shaft 142 by pins 149 so that the bushings move together with the idler shaft.

The idler shaft, and therefor the idler gear, is biased to the position shown in FIG. 14, by a spring 155. The spring bears at one against the lower bushing 146 and at its opposite end against a cap 153 fixed to the end of the idler shaft 142 by a screw 154. In this position, the idler gear 126 meshes with both the motor-driven gears 121 and the steering gear 110 mounted to the steering shaft SS. This orientation is schematically depicted in FIG. 15. In accordance with the present invention, the idler gear may be translated upward to the position 126′. In this orientation, the idler gear still meshes with the drive gears 121, albeit at a smaller engagement 160. This limited engagement 160 ensures that the idler gear will remain meshed with the drive gears when the idler gear is returned to its normal engagement position 126.

On the other hand, when the idler gear is translated upward, it is no longer meshed with the steering gear 110, as signified by the region 162. Thus, even if the idler gear is rotated by a spurious steering signal through the steering assembly 34, no rotational force will be imparted to the steering gear, since the idler gear is no longer engaged. In this disengaged position, the steering shaft SS can rotate under operation of the stock vehicle steering wheel S without any rotational resistance from the steering assembly 34. When the idler shaft is returned to its normal position, the idler gear will mesh with the steering gear after only a very minimal amount of rotation, as the corresponding gear teeth align.

The idler shaft 142 includes a threaded bore 158 at its upper end for attachment to a retraction mechanism 160 to shift the idler shaft vertically upward, as indicated by the arrow in FIG. 15. The retraction mechanism 160 can be mounted on the frame 135 or independent of the steering mechanism. In a preferred embodiment, the retraction mechanism is a cable that is pulled, similar to the emergency brake release cable on a typical automobile. The working end of the cable is threaded into the bore 158 and can be reacted against a cable mount (not shown) fixed to the frame 135 or the vehicle adjacent the frame. The cable can be manually activated by pulling the free end of the cable, using a handle, a key lock or a solenoid, all as known in the art.

In an alternative embodiment, the mechanism is a solenoid having one end of its plunger engaged in the threaded bore 158. The solenoid is electrically activated by a signal preferably generated by the controller 32. Alternatively, the signal may be generated by a separate switch independent of the controller, such as the key switch 39 on the annunciator panel 38. In this case, the key switch is not turned on by a person driving the vehicle does not require the steering assist provided by the steering apparatus 34 of the present invention. Whether controlled by the controller 32 or a separate switch, an override is provided to prevent actuation of the retraction mechanism 160 (i.e., de-activation of the steering assist feature) while the vehicle is being operated by a physically impaired driver. This over-ride can be in the form of a lock-out for the key switch 39 in which the key is removed when the key switch is turned on.

As a further aspect of this embodiment, the potentiometer gears 131 remain meshed with the steering gear. With this aspect, the potentiometers will remain in calibration, since they are not disengaged and re-engaged to the steering gear at some unknown rotational position. Otherwise, if the gears 131 were disengaged from the steering gear, their neutral reference would be disturbed and would be inaccurately based on the steering shaft rotational position when the gears were re-engaged.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A steering system for a motor vehicle having a steering shaft connected to a stock steering wheel, said system comprising:
an input device independent of the stock steering wheel operable by the driver to generate a control signal indicative of a desired steering input for the vehicle;
a controller receiving said control signal and operable to generate a steering command in relation thereto; and
a steering apparatus including;
a steering gear coupled to the vehicle steering shaft so that rotation of said steering gear rotates the steering shaft;
at least three drive gears;
an idler gear in meshed engagement with said steering gear and said drive gears to transmit rotation from said drive gears to said steering gear; and
at least three motors each driving a corresponding one of said drive gears in response to said steering command received from said controller.

2. The steering system of claim 1, wherein said steering apparatus includes a mechanism coupled to said idler gear operable to disengage said idler gear from said drive gears.

3. The steering system of claim 2, wherein said mechanism is operable to shift the idler gear to a retracted position in relation to said steering gear in which the idler and steering gears are no longer in engagement.

4. The steering system of claim 3, wherein said drive gears are configured so that the idler gear remains meshed with said drive gears when said idler gear is in said retracted position.

5. A steering system for a motor vehicle having a steering shaft connected to a stock steering wheel, said system comprising:
an input device independent of the stock steering wheel operable by the driver to generate a control signal indicative of a desired steering input for the vehicle;
a controller receiving said control signal and operable to generate a steering command in relation thereto; and
a steering apparatus including;
a steering gear coupled to the vehicle steering shaft so that rotation of said steering gear rotates the steering shaft;
a drive gear;
a motor rotating said drive gear in response to said steering command received from said controller;
an idler gear in meshed engagement with said steering gear and said drive gears to transmit rotation from said drive gears to said steering gear; and
a mechanism coupled to said idler gear operable to disengage said idler gear from said drive gear.

6. The steering system of claim 5, wherein said mechanism is operable to shift the idler gear to a retracted position in relation to said steering gear in which the idler and steering gears are no longer in engagement.

7. The steering system of claim 6, wherein said drive gear is configured so that the idler gear remains meshed with said drive gear when said idler gear is in said retracted position.

8. The steering system of claim 5, wherein:
said idler gear includes an idler shaft about which said idler gear rotates; and
said mechanism includes a solenoid coupled to said idler shaft to translate said shaft to disengage said idler gear from said steering gear.

9. A control system for a motor vehicle having stock controls including a steering shaft connected to a stock steering wheel, a stock brake pedal and a stock accelerator pedal, said system comprising:
an input device independent of the vehicle stock controls operable by the driver to generate control signals indicative of a desired steering input and a desired braking/acceleration input for the vehicle, wherein said input device includes;
a two-axis joystick mounted on a gimbal so that said joystick can be pivoted in two mutually perpendicular directions;
a first gear coupled to said gimbal and rotatable in a first of said perpendicular directions;
a first position sensor driven by said first gear and operable to produce a steering signal in relation to the rotation of said first gear;
a second gear coupled to said gimbal and rotatable in a second of said perpendicular directions; and
a second position sensor driven by said second gear and operable to produce a braking/acceleration signal in relation to the rotation of said second gear;
a controller receiving said steering signal and operable to generate a steering command in relation thereto and receiving said braking/acceleration signal and operable to generate a braking/acceleration command in relation thereto;
a steering apparatus including;
a steering gear coupled to the vehicle steering shaft so that rotation of said steering gear rotates the steering shaft; and
a motor-driven drive gear train in meshed engagement with said steering gear and operable to rotate said steering gear in response to said steering command received from said controller; and
a braking/steering apparatus including;
a motor-driven brake actuator coupled to the stock brake pedal and operable to depress the brake pedal in response to said braking/acceleration signal; and
a motor-driven accelerator actuator coupled to the stock accelerator pedal and operable to depress the accelerator pedal in response to said braking/acceleration command received from said controller.

10. The control system of claim 9, wherein:
said input device includes a first limit switch associated with said second gear and operable at a pre-determined limit position of said second gear to produce a first limit signal; and
said controller is operable upon receipt of said first limit signal to deactivate said motor-driven accelerator actuator to prevent depression of the stock accelerator pedal.

11. The control system of claim 9, wherein:
said control system further comprises an emergency braking system;
said input device includes a second limit switch associated with said second gear and operable at a pre-determined limit position of said second gear to produce a second limit signal; and
said controller is operable upon receipt of said second limit signal to activate said emergency braking system.

12. A steering system for a motor vehicle having a steering shaft connected to a stock steering wheel, said system comprising:
an input device independent of the stock steering wheel operable by the driver to generate a control signal indicative of a desired steering input for the vehicle;
an accelerometer mounted within the vehicle and operable to generate an lateral acceleration signal in relation to the lateral acceleration of the vehicle;
a controller receiving said control signal and said lateral acceleration signal, said controller operable to generate a steering command in relation to said control signal that is reduced in relation to the magnitude of said lateral acceleration signal only when said lateral acceleration signal is greater than a pre-determined magnitude; and
a steering apparatus including;
a steering gear coupled to the vehicle steering shaft so that rotation of said steering gear rotates the steering shaft; and
a motor-driven drive train in meshed engagement with said steering gear and operable to rotate said steering gear in response to a steering command issued by said controller.
